(19) United States
(12) Patent Application Publication
(10) Pub. No.: US 2017/0337915 A1
(43) Pub. Date: Nov. 23, 2017

(54) SYSTEM AND METHOD FOR CONTROLLING SOUND CHARACTER FOR A VEHICLE

(71) Applicant: GM GLOBAL TECHNOLOGY OPERATIONS LLC, Detroit, MI (US)

(72) Inventors: Frank C. Valeri, Novi, MI (US); Scott M. Reilly, Southfield, MI (US); Roger C. Barlow, JR., Brighton, MI (US); William Seldon, Highland, MI (US)

(21) Appl. No.: 15/161,991

(22) Filed: May 23, 2016

(51) Int. Cl. G10K 11/175

(52) U.S. Cl. CPC G10K 11/175; G10K 2210/1282

(57) ABSTRACT

A system for controlling sound character of a vehicle includes one or more performance enhancement systems operable to enhance powertrain performance. Each of the one or more performance enhancement systems includes a performance control input. One or more sound enhancement systems are operable to adjust at least one of an external vehicle sound and an interior sound perceived by vehicle occupants. Each of the one or more sound enhancement system includes a sound enhancement control input. A sound character control system includes a central controller operably connected to at least one performance control input and at least one sound enhancement control input. The central controller coordinates operation of at least two of the one or more performance enhancement systems and the one or more sound enhancement systems to establish one of a desired exterior sound character and an interior sound character.

### FIELD OF THE INVENTION

The subject invention relates to the art of vehicles and, more particularly, to a system for establishing and controlling a desired sound character for a vehicle.

### BACKGROUND

Vehicle owners may be concerned with undesirable sounds that may exist in a vehicle interior or externally of a vehicle. Often times, the undesirable noise may be generated by various vehicle components as well as interactions between components and environmental conditions. When present, undesirable noise may detract from the overall enjoyment of the vehicle. Current systems employ one or more speakers to cover undesirable sound or add noise to enhance or provide desirable sounds. Other systems may include exhaust and/or fuel controls. While somewhat effective, speakers and engine controls cannot accommodate all undesirable sounds in a passenger compartment particularly when operated without any coordination. Accordingly, it is desirable to provide a system that employs multiple components, all working in harmony to promote a more enjoyable interior environment for the vehicle.

### SUMMARY OF THE INVENTION

In accordance with an exemplary embodiment, a system for controlling sound character of a vehicle includes one or more performance enhancement systems operable to enhance powertrain performance. Each of the one or more performance enhancement systems includes a performance control input. One or more sound enhancement systems are operable to adjust at least one of an external vehicle sound and an interior sound perceived by vehicle occupants. Each of the one or more sound enhancement system includes a sound enhancement control input. A sound character control system includes a central controller operably connected to at least one performance control input and at least one sound enhancement control input. The central controller coordinates operation of at least two of the one or more performance enhancement systems and the one or more sound enhancement systems to establish one of a desired exterior sound character and an interior sound character.

In accordance with another aspect of an exemplary embodiment, a vehicle includes a body, and a powertrain supported in the body. The powertrain includes an engine, a transmission and one or more performance enhancement systems operable to enhance powertrain performance. Each of the one or more performance enhancement systems includes a performance control input. One or more sound enhancement systems are operable to adjust at least one of an external vehicle sound and an interior sound perceived by vehicle occupants. Each of the one or more sound enhancement system includes a sound enhancement control input. A sound character control system includes a central controller operably connected to at least one performance control input and at least one sound enhancement control input. The central controller coordinates operation of at least two of the one or more performance enhancement systems and the one or more sound enhancement systems to established one of a desired exterior sound character and an interior sound character.

In accordance with yet another aspect of an exemplary embodiment, a method of controlling a sound character of a vehicle includes monitoring powertrain conditions, determining a status of one or more performance enhancement systems operable to enhance powertrain performance, determining a status of one or more sound enhancement systems operable to adjust at least one of an external vehicle sound and an interior sound perceived by vehicle occupants, and coordinating operation of at least two of the one or more performance enhancement systems and the one or more sound enhancement systems to establish one of a desired exterior sound character and an interior sound character.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic view of a vehicle having a sound character control system, in accordance with an exemplary embodiment;

FIG. 2 is a schematic representation of a sound character control system, in accordance with an aspect of an exemplary embodiment; and

FIG. 3 is a flow chart depicting a method of controlling sound character in a vehicle, in accordance with an aspect of an exemplary embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features. As used herein, the term “module” or “unit” refers to an application specific integrated circuit (ASIC), a field programmable gate array (FPGA), an electronic circuit, an electronic computer processor (shared, dedicated, or group) and memory that executes one or more software or firmware programs, a hardware microcontroller, a combinational logic circuit, and/or other suitable components that provide the described functionality. When implemented in software, a module can be embodied in memory as a non-transitory machine-readable storage medium readable by a processing circuit and storing instructions for execution by the processing circuit for performing a method.

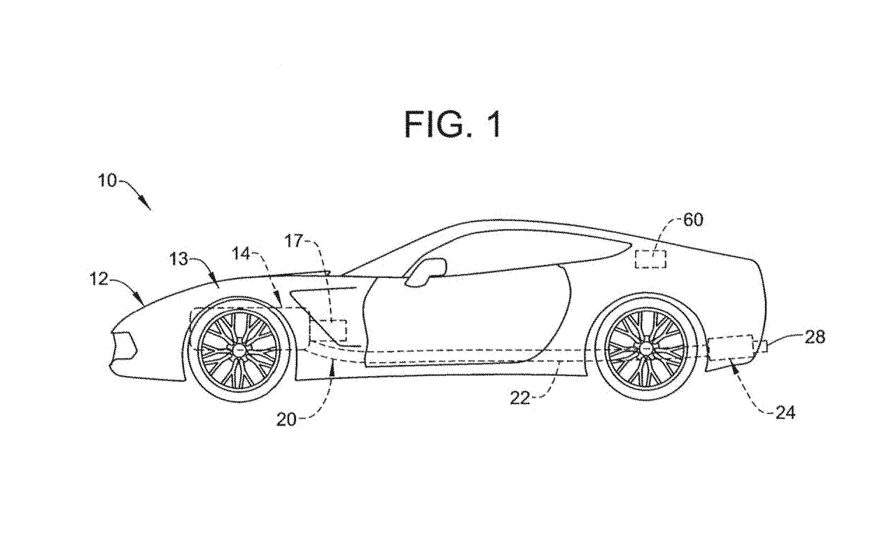

A vehicle, in accordance with an exemplary embodiment, is illustrated generally at 10 in FIG. 1. Vehicle 10 includes a chassis (not shown) that supports a body 12 and a powertrain 13. Powertrain 13 includes an engine 14 operatively coupled to a transmission 17. Transmission 17 is operatively connected to drive wheels (not separately labeled) through a drive shaft (also not shown). Vehicle 10 also includes an exhaust system 20 having an exhaust pipe 22 that extends from fluidically connects between engine 14 and a sound attenuation device or muffler 24. A tail pipe 28 extends from muffler 24 and serves to discharge exhaust gases from engine 14 to ambient. Of course, it should be understood that vehicle 10 may constitute an electric vehicle or a hybrid electric vehicle.

In accordance with an aspect of an exemplary embodiment, vehicle 10 includes a sound character control system 60 that coordinates activation of various vehicle components to achieve a desired external or exterior sound character and/or internal sound character associated with vehicle 10. The term “sound character” should be understood to describe a desired quality, level, and/or tone emitted by powertrain 13 and perceivable externally of and/or internally to, vehicle 10. The “sound character” may also represent desired performance characteristics of vehicle 10 while maintaining externally perceived sounds within sound emission standards.

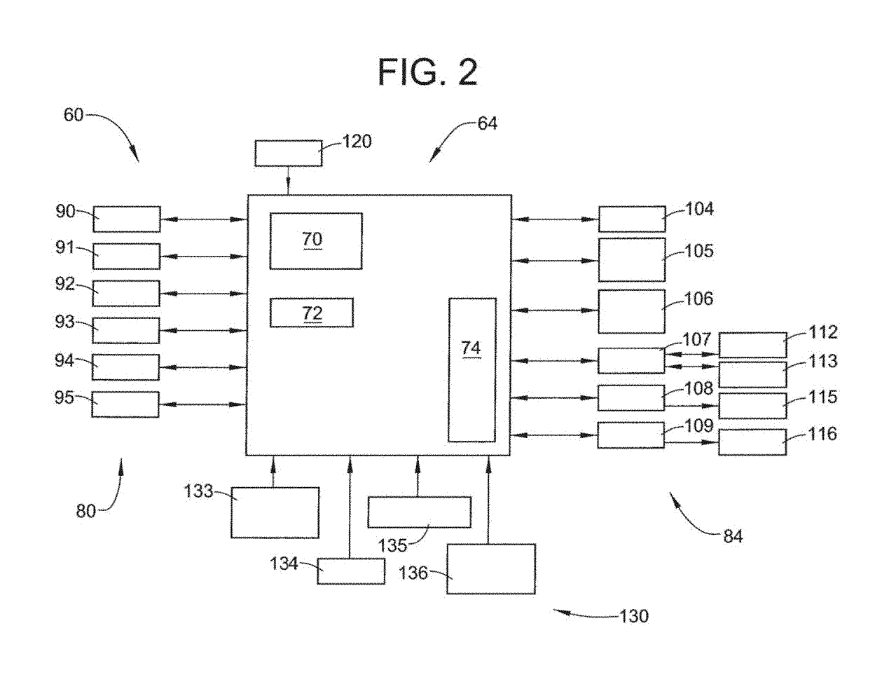

As seen in FIG. 2, sound character control system 60 includes a central controller 64 having a processor 70, a non-volatile memory 72 and a sound character coordination module or controller 74 that coordinates operation of various vehicle components to achieve the desired sound character of vehicle 10. Central controller 64 may be operatively coupled to a plurality of performance enhancement systems 80 and a plurality of sound enhancement systems 84. Performance enhancement systems 80 may be selectively operated to establish desired powertrain performance characteristics for vehicle 10 and may include one or more of an engine calibration controller (EC) 90, a fuel controller (FC) 91, a turbocharger waste gate controller (WG) 92, a transmission calibration controller (TC) 93, an advanced fuel management system (AFM) 94 that may selectively activate and deactivate operation of cylinders (not shown) in engine 14 and a drive control module (95) that may allow a user to select between a performance mode, a street mode, and/or other driving modes for vehicle 10. Each performance enhancement system 80 includes at least one corresponding performance control input (not separately labeled) to sound character control system 60.

Sound enhancement systems 84 may be selectively activated to achieve a desired audible response from a vehicle component. Sound enhancement systems 84 may operate to add sound to existing sound signatures for a component, or may attenuate sound from the existing sound signatures. Sound enhancement systems 84 may include one or more of an engine sound enhancement system (ENC) 104, an exhaust sound quality valve (Exh SQV) 105, a mechanical sound enhancer(s) (MECH SE) 106, an active noise cancellation system (ANC) 107, an exhaust dynamic sound quality system (EDST) 108, and an exhaust dynamic noise cancellation system (EDNC) 109. ANC 107 may include one or more transducers 112, that may take the form of microphones and/or accelerometers 112 that capture noise and one or more speakers 113 that emit sounds. EDST 108 may include speakers 115 and EDNC 109 may include speakers 116. Speakers 115 may be operated to enhance exhaust sounds while speakers 116 may be operated to attenuate or mask exhaust sounds. Each sound enhancement system 84 may include one or more sound enhancement control inputs to sound character control system 60. Additional transducers 120, which may also take the form of microphones and/or accelerometers, arranged in various portions of vehicle 10 may also be operatively connected to central controller 64.

Sound enhancement systems 84 may also include one or more powertrain inputs 130 including one or more of an accelerator pedal sensor 133, an engine torque sensor (ET) 134, an RPM rate of change sensor (RPM RoC) 135, and a pedal position sensor 136. As will be detailed more fully below, sound enhancement systems 84 receives one or more of powertrain inputs 130 to determine a desired sound character. Sound character coordination module 74 may then derive the desired sound character from values, settings, and the like stored in non-volatile memory 72. Sound character coordination module 74 establishes the desired sound character by coordinating control of one or more of the performance enhancement systems 80 and the sound enhancement systems 84. That is, sound character coordination module 74 operates as would a conductor to achieve a desired sound character by orchestrating control of multiple sources to achieve a desired sound. At this point, it should be understood that control of a system may include activating a system and may also include allowing a system to exist in a deactivated state.

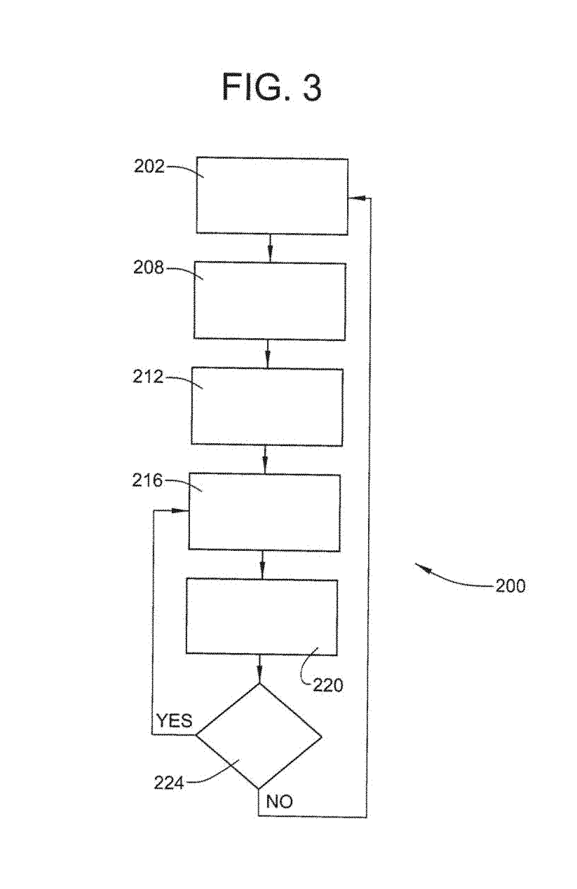

Reference will now follow to FIG. 3 in describing a method 200 of enhancing a sound character of vehicle 10 in accordance with an exemplary embodiment. In block 202, sound character control system 60 monitors powertrain inputs 130 for signals indicating a need for sound character adjustment. In block 208, sound character control system 60 determines a current state of each performance enhancement system 80 and in block 212 sound character control system 60 determines a status of each sound enhancement system 84. In block 216, sound character coordination module 74 coordinates control of one or more of performance enhancement systems 80 and sound enhancement systems 84 to establish a desired sound character.

In block 220, sound character control system 60 monitors sound through one or more of microphones and/or accelerometers 112, 120. The monitored signals or sounds captured by transducers 112, 120 may be compared against desired sound characteristics stored in non-volatile memory 72 and a determination is made, in block 224, whether sound character adjustments are indicated. If sound character adjustments are indicated, sound character coordination module 74 may coordinate operation of one or more of performance enhancement systems 80 and sound enhancement systems 84 until the desired sound character is achieved. Once the desired sound character is achieved, sound character control system 60 continues to monitor powertrain inputs 130 in block 202.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A system for controlling sound character of a vehicle comprising:
one or more performance enhancement systems operable to enhance powertrain performance, each of the one or more performance enhancement systems including a performance control input;
one or more sound enhancement systems operable to adjust at least one of an external vehicle sound and an interior sound perceived by vehicle occupants, each of the one or more sound enhancement system including a sound enhancement control input; and
a sound character control system including a central controller operably connected to at least one performance control input and at least one sound enhancement control input, the central controller coordinating operation of at least two of the one or more performance enhancement systems and the one or more sound enhancement systems to establish one of a desired exterior sound character and an interior sound character.

2. The system of claim 1, wherein the central controller further includes a powertrain input providing one of a change in RPM signal, a pedal position signal, and an engine torque signal, the central controller coordinating operation of at least two of the one or more performance enhancement systems and the one or more sound enhancement systems to establish the one of the desired exterior sound character and the interior sound character based on a powertrain input.

3. The system of claim 1, wherein the one or more performance enhancement systems include one or more of a fuel controller, a turbocharger waste gate controller, an engine calibration controller, a transmission calibration controller, a drive control module, and an advanced fuel management system.

4. The system of claim 1, wherein the one or more sound enhancement systems include one or more of an active noise cancellation system, a mechanical sound enhancer, a sound quality valve, an engine sound enhancement system, and an exhaust dynamic sound quality system.

5. The system according to claim 1, further comprising: one or more transducers operatively connected to the central controller, the central controller adjusting the one of the desired exterior sound character and the interior sound character based on inputs received by the one or more transducers.

6. The system according to claim 5, wherein the one or more transducers include at least one transducer operatively connected to an active noise cancellation system.

7. The system of claim 1, wherein the one or more performance enhancement systems include a plurality of performance enhancement systems and the one or more sound enhancement systems include a plurality of sound enhancement systems, the central controller coordinating operation of each of the plurality of performance enhancement systems and each of the plurality of sound enhancement systems to establish one of a desired exterior sound character and an interior sound character.

8. A vehicle comprising:
a body;
a powertrain supported in the body, the powertrain including an engine, a transmission and one or more performance enhancement systems operable to enhance powertrain performance, each of the one or more performance enhancement systems including a performance control input;
one or more sound enhancement systems operable to adjust at least one of an external vehicle sound and an interior sound perceived by vehicle occupants, each of the one or more sound enhancement system including a sound enhancement control input; and
a sound character control system including a central controller operably connected to at least one performance control input and at least one sound enhancement control input, the central controller coordinating operation of at least two of the one or more performance enhancement systems and the one or more sound enhancement systems to establish one of a desired exterior sound character and an interior sound character.

9. The vehicle according to claim 8, wherein the central controller further includes a powertrain input operatively connected to one of the engine and the transmission, the powertrain input providing one of a change in RPM signal, a pedal position signal, and an engine torque signal, the central controller coordinating operation of at least two of the one or more performance enhancement systems and the one or more sound enhancement systems to establish the one of the desired exterior sound character and the interior sound character based on the powertrain input.

10. The vehicle according to claim 8, wherein the one or more performance enhancement systems include one or more of a fuel controller, a turbocharger waste gate controller, an engine calibration controller, a transmission calibration controller, a drive control module, and an advanced fuel management system.

11. The vehicle according to claim 8, wherein the one or more sound enhancement systems include one or more of an active noise cancellation system, a mechanical sound enhancer, a sound quality valve, an engine sound enhancement system, and an exhaust dynamic sound quality system.

12. The vehicle according to claim 8, further comprising: one or more transducers operatively connected to the central controller, the central controller adjusting the one of the desired exterior sound character and the interior sound character based on inputs received by the one or more transducers.

13. The vehicle according to claim 12, wherein the one or more transducers include at least one transducer operatively connected to an active noise cancellation system.

14. The vehicle according to claim 8, wherein the one or more performance enhancement systems include a plurality of performance enhancement systems and the one or more sound enhancement systems include a plurality of sound enhancement systems, the central controller coordinating operation of each of the plurality of performance enhancement systems and each of the plurality of sound enhancement systems to establish one of a desired exterior sound character and an interior sound character.

15. A method of controlling a sound character of a vehicle comprising:
monitoring powertrain conditions;
determining a status of one or more performance enhancement systems operable to enhance powertrain performance;
determining a status of one or more sound enhancement systems operable to adjust at least one of an external vehicle sound and an interior sound perceived by vehicle occupants; and
coordinating operation of at least two of the one or more performance enhancement systems and the one or more sound enhancement systems to establish one of a desired exterior sound character and an interior sound character.

16. The method of claim 15, wherein determining the status of the one or more performance enhancement systems includes determining a status of one or more of a fuel controller, a turbocharger waste gate controller, an engine calibration controller, a transmission calibration controller, a drive control module, and an advanced fuel management system.

17. The method of claim 15, wherein determining the status of the one or more sound enhancement systems includes determining a status of one or more of an active noise cancellation system, a mechanical sound enhancer, a sound quality valve, an engine sound enhancement system, and an exhaust dynamic sound quality system.

18. The method of claim 15, further comprising:
monitoring the exterior sound character and the interior sound character; and
adjusting one or more of the performance enhancement systems and the sound enhancement systems to establish the one of the desired exterior sound character and the interior sound character.

19. The method of claim 15, further comprising: monitoring a powertrain input to establish a baseline for the one of the desired exterior sound character and the interior sound character.

20. The method of claim 19, wherein monitoring the powertrain input includes monitoring one or more of a change in RPM signal, a pedal position signal, and an engine torque signal.
